(19) United States
(12) Patent Application Publication
(10) Pub. No.: US 2025/0322330 A1
(43) Pub. Date: Oct. 16, 2025

(54) INFORMATION PROCESSING APPARATUS, METHOD FOR CONTROLLING THE SAME, AND STORAGE MEDIUM

(71) Applicant: CANON KABUSHIKI KAISHA, Tokyo (JP)

(72) Inventor: YOSHIHISA SATO, Kanagawa (JP)

(21) Appl. No.: 19/172,302

(22) Filed: Apr. 7, 2025

(30) Foreign Application Priority Data
Apr. 15, 2024 (JP) 2024-065450

(51) Int. Cl. G06Q 10/0631; G06Q 10/047

(52) U.S. Cl. CPC G06Q 10/063112; G06Q 10/047

(57) ABSTRACT

A moving object information acquisition unit acquires information about a moving object under management. If a problem occurs to disturb a task execution by the moving object, a problem information acquisition unit acquires information about details of the problem. A personal information acquisition unit acquires attribute information about at least one candidate of a problem-solving person. A person selection unit selects a problem-solving person from the at least one candidate based on the information about the moving object acquired by the moving object information acquisition unit, the information about details of the problem acquired by the problem information acquisition unit, and the attribute information about the at least one person acquired by the personal information acquisition unit.

### BACKGROUND

### Field

The present disclosure relates to an information processing apparatus, a method for controlling the information processing apparatus, and a storage medium.

### Description of the Related Art

In recent years, the use of robots (hereinafter referred to as moving objects) capable of autonomously moving in factory production lines, transport warehouses, hospitals, and other human working environments has improved the working efficiency in transportation of articles in increasing number of cases. At present, many of environments where the above-described robots are used are suitable for human working. Since many of mobile robots (moving objects) have difficulty in flexibly coping with tasks like persons, there may arise not a few situations where the task execution by moving objects is difficult. Japanese Patent Application Laid-Open No. 2022-126658 discusses a technique for solving a problem arising when a moving object faces an exceptional event during the task execution. The technique requests a person at a remote location to perform a remote operation. Japanese Patent Application Laid-Open No. 2000-342496 also discusses a technique for solving a problem arising when a moving object enters an inoperable state. The technique calls a security guard in a guard room.

If a problem occurs to disturb the task execution by a moving object, the techniques discussed in Japanese Patent Application Laid-Open No. 2022-126658 and Japanese Patent Application Laid-Open No. 2000-342496 may find it difficult to solve the problem or take time even if the problem is barely solved.

### SUMMARY

The present disclosure is directed to, if a problem occurs to disturb the task execution by a moving object, solve the problem in a more suitable form.

According to an aspect of the present disclosure, an information processing apparatus includes a moving object information acquisition unit configured to acquire information about a moving object under management, a problem information acquisition unit configured to, if a problem occurs to disturb a task execution by the moving object, acquire information about details of the problem, a personal information acquisition unit configured to acquire attribute information about at least one candidate of a problem-solving person, and a person selection unit configured to select a problem-solving person from the at least one candidate based on the information about the moving object acquired by the moving object information acquisition unit, the information about details of the problem acquired by the problem information acquisition unit, and the attribute information about the at least one person acquired by the personal information acquisition unit.

Further features of the present disclosure will become apparent from the following description of exemplary embodiments with reference to the attached drawings.

### BRIEF DESCRIPTION OF THE DRAWINGS

FIG. 1 illustrates an example of a hardware configuration of an information processing apparatus.

FIG. 2 is a conceptual view illustrating a scene where the information processing apparatus is applied.

FIG. 3 illustrates an example of a functional configuration of the information processing apparatus.

FIG. 4 is a flowchart illustrating an example of processing of the information processing apparatus.

FIG. 5 is a flowchart illustrating another example of processing of the information processing apparatus.

FIG. 6 illustrates another example of a functional configuration of the information processing apparatus.

FIG. 7 is a flowchart illustrating still another example of processing of the information processing apparatus.

FIG. 8 illustrates an example of contents of a notification transmitted to a problem-solving person.

FIG. 9 illustrates another example of contents of a notification transmitted to the problem-solving person.

FIG. 10 illustrates still another example of a functional configuration of the information processing apparatus.

FIG. 11 is a flowchart illustrating still another example of processing of the information processing apparatus.

FIG. 12 illustrates still another example of a functional configuration of the information processing apparatus.

### DESCRIPTION OF THE EMBODIMENTS

Exemplary embodiments of the present disclosure will be described below with reference to the accompanying drawings.

In the present specification and drawings, elements having substantially identical functions are assigned the same reference numerals and duplicated descriptions thereof will be omitted.

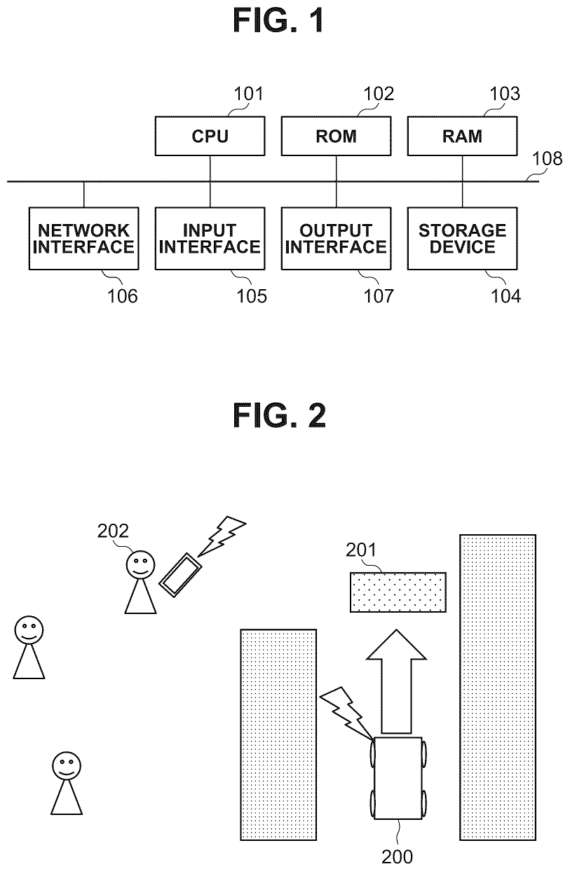

An example of a hardware configuration of an information processing apparatus 100 applied to implement a technique according to an exemplary embodiment of the present disclosure will be described below with reference to FIG. 1. Functional configurations and processing of exemplary embodiments (described in detail below) may be implemented by a single apparatus or implemented by a plurality of apparatuses in a collaborative way. If a plurality of apparatuses collaborates with each other, functions of a series of components according to exemplary embodiments may be distributedly implemented in a plurality of apparatuses, or processing loads of at least some of components may be distributed in a plurality of apparatuses. If a plurality of apparatuses is operated in a collaborative way, the plurality of apparatuses may be connected via a network such as a Local Area Network (LAN) so that they can communicate with each other.

A Central Processing Unit (CPU) 101 is a central processing unit that controls the overall operations of the information processing apparatus 100. A Read Only Memory (ROM) 102 is a storage area for storing programs and parameters that do not need to be modified. A Random Access Memory (RAM) 103 is a storage area for temporarily storing programs and data supplied from an external apparatus.

An external storage device 104 is a storage area for storing various types of data and programs, and can be implemented by a hard disk or memory card. The external storage device 104 may be fixed to the information processing apparatus 100 or configured to be attachable to and detachable from the information processing apparatus 100. Examples of apparatuses applicable as the external storage device 104 include a flexible disk (FD), an optical disc such as a compact Disk (CD), a magnetic card, an optical card, an Integrated Circuit (IC) card, and a memory card.

An input interface 105 is used to connect an input apparatus 109 such as a pointing device and a keyboard to the information processing apparatus 100. A network interface 106 is used to connect the information processing apparatus 100 to a network such as the Internet. An output interface 107 is used to connect an output device 110 such as a monitor that displays images for data stored in the information processing apparatus 100 and data supplied to the information processing apparatus 100.

Components of the above-described information processing apparatus 100 are connected so that they can communicate data with each other via a system bus 108.

The present disclosure is directed to supplying a storage medium that stores the program code of software for implementing the functions of exemplary embodiments (described below) to a system or apparatus. The present disclosure is also achieved when the system or apparatus reads and executes the program code stored in the storage medium. In this case, the program code itself read from the storage medium will implement the functions of the exemplary embodiments (described below), and the storage medium storing the program code will configure the present disclosure.

Examples of storage media for supplying the program code include a flexible disk, a hard disk, an optical disk, and a magneto-optical disk. Examples of usable storage media also include a compact disc read only memory (CD-ROM), a compact disc recordable (CD-R), a magnetic tape, a nonvolatile memory card, a ROM, and a digital versatile disc (DVD).

The program code may be directly executed by a computer or processed by an Operating System (OS) operating on a computer.

The program code read from a storage medium may be processed by a function expansion board inserted into the computer or a function expansion unit connected thereto.

A first exemplary embodiment of the present disclosure will be described below. The overview of the information processing apparatus according to the first exemplary embodiment will be described below with reference to FIG. 2. FIG. 2 is a conceptual view illustrating a scene where the information processing apparatus according to the present exemplary embodiment is applied. The example illustrated in FIG. 2 includes a moving object 200, an obstacle 201, and a problem-solving person 202.

The example in FIG. 2 illustrates a situation where the moving object 200 is executing a task that necessitates the moving object 200 to move in the direction of the arrow. In this case, since the obstacle 201 exists on the path of the moving object 200, a problem occurs to disable the continuous task execution by the moving object 200. Under such a situation, this problem may be solved, for example, by selecting a person, which has a skill to solve the problem, near the occurrence position of the problem.

There is proposed a method for solving a problem that has occurred on a moving object. More specifically, if the problem occurs to disturb the task execution by the moving object, the information processing apparatus according to the present exemplary embodiment selects a problem-solving person based on the distance from the occurrence position of the problem and the personal skill.

The information processing apparatus according to the present exemplary embodiment may be included in the moving object 200. In this case, the information processing apparatus manages the moving object 200 in which the apparatus is included. If the apparatus detects the occurrence of a problem of the moving object 200, the apparatus may select a person who can solve the problem. As another example, the information processing apparatus may be implemented as an external apparatus that can wirelessly communicate with the moving object 200 through wireless communication. In this case, the information processing apparatus may manage not only one moving object 200 but also a plurality of the moving objects 200.

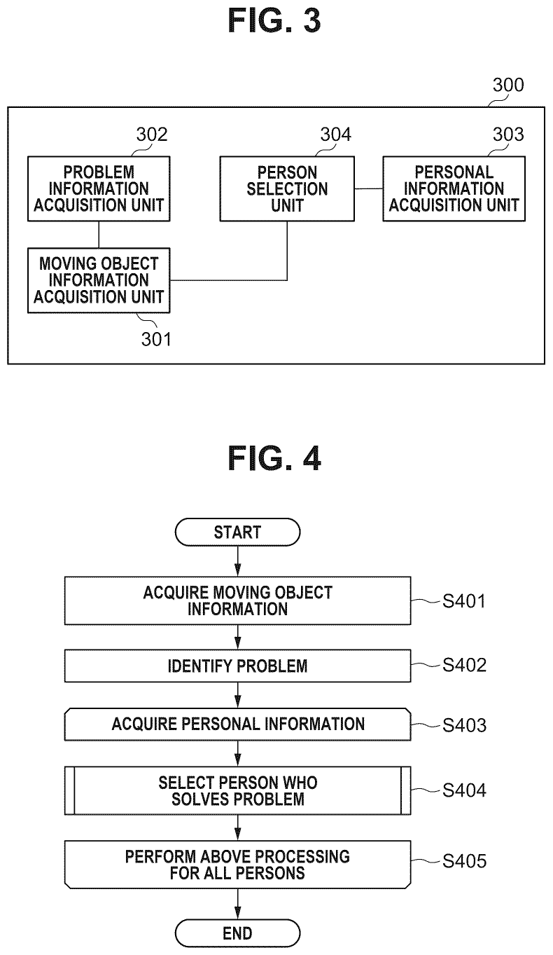

An example of a functional configuration of the information processing apparatus according to the present exemplary embodiment will be described below with reference to FIG. 3.

An information processing apparatus 300 includes a moving object information acquisition unit 301, a problem information acquisition unit 302, a personal information acquisition unit 303, and a person selection unit 304.

The moving object information acquisition unit 301 acquires various types of information about the moving object under management.

The problem information acquisition unit 302 acquires information about a problem that has occurred on the moving object under management. As a specific example, the problem information acquisition unit 302 may acquire the type of the problem that has occurred on the moving object under management and information about the occurrence position of the problem.

The personal information acquisition unit 303 acquires information (personal attribute information) about at least one candidate of a person who solves the problem that has occurred on the moving object under management. As a specific example, the personal information acquisition unit 303 may acquire information about persons existing in the environment where the moving object under management is operating.

The person selection unit 304 selects a person who can solve the problem from among at least one person whose information has been acquired by the personal information acquisition unit 303. More specifically, the person selection unit 304 selects a person who can solve the problem that has occurred on the moving object, based on attribute information about the person acquired by the personal information acquisition unit 303, information about the problem acquired by the problem information acquisition unit 302, and information about the moving object acquired by the moving object information acquisition unit 301.

An example of processing of the information processing apparatus 300 according to the present exemplary embodiment will be described below with reference to FIG. 4.

In step S401, the moving object information acquisition unit 301 acquires information about the moving object under management. For example, the moving object information acquisition unit 301 acquire the positional information about the moving object under management, the task being executed by the moving object, and the importance of the task. For example, the target moving object manages these pieces of information about the moving object itself by using a database, extracts information from the database in response to a request from the information processing apparatus 300, and transmits the information. The positional information about the moving object may be acquired by using a positioning system represented by Global Positioning System (GPS) or a self-position estimation technique.

In step S402, the problem information acquisition unit 302 identifies the type of the problem that has occurred on the moving object under management and the occurrence position of the problem, based on the information about the moving object acquired in step S401.

Examples of types of problems to be identified include a problem of a closed door on the path, a problem of the path blocked by the cargo, a problem of the collapsed cargo on the moving object, and a problem of run-off of the moving object. To identify the types of these problems, the problem information acquisition unit 302 may use the result of the state detection acquired by using various types of sensors, and information acquired from a central calculation apparatus for managing various states in the environment where the moving object is operating.

As a specific example, if the moving object scans the path by using laser sensors installed thereon and detects an obstacle blocking the path, the moving object determines the occurrence of a problem of the path blocked by the cargo.

The moving object acquires opening/closing information about doors on the path to the destination from a central management apparatus for managing opening/closing information about doors in the environment where the moving object is operating. This enables the moving object to determine the presence or absence of a problem of a closed door on the path.

If an image recognition technique is applied to images corresponding to the result of capturing the periphery of the moving object by an imaging apparatus installed on the moving object, information about the periphery of the moving object can be analyzed. This analysis enables detecting, for example, the occurrence of a problem of the collapsed cargo.

The moving object can also monitor variations of the position of the moving object based on a self-position estimation technique using an imaging apparatus, a GPS sensor, and an acceleration sensor installed on the moving object. This enables the moving object to determine that a problem of run-off occurs, for example, if the position of the moving object remains unchanged while the wheels of the moving object are driven.

The problem information acquisition unit 302 can identify the occurrence position of the problem, for example, based on the result of detecting an obstacle by using laser sensors installed on the moving object and the result of estimating the self-position of the moving object. As a specific example, the problem information acquisition unit 302 can identify the occurrence position (absolute position) of the problem by measuring the relative position of the obstacle or closed door from the moving object by using laser sensors and then comparing the relative position with the self-position included in the moving object information acquired in step S401. If the cargo on the moving object collapses or if the moving object runs off, the moving object only needs to identify the self-position included in the moving object information acquired in step S401 as the occurrence position of the problem.

In step S403, the personal information acquisition unit 303 acquires attribute information about each of the persons under management (hereinafter also referred to as personal information) and repetitively executes the series of processes indicated by the loop symbols in steps S403 and S405. Examples of acquired personal information include the contact address, the personal skill, the currently active task, the priority of the active task, and the current position. Examples of personal information about a plurality of persons under management include information managed through a database such as a person list (Table 1 below) and a task list (Table 2 below).

TABLE 1

| | Contact | Personal | Active | Current |
|---|---|---|---|---|
| ID | address | skill | task ID | location |
| 1 | aaa@email.com | Lift heavy load | 2 | 1111, 2222 |
| 2 | bbb@email.com | | — | 3333, 4444 |
| 3 | ccc@email.com | Lift heavy load | 1 | 5555, 6666 |
| 4 | ddd@email.com | Lift heavy load | — | 7777, 8888 |
| 5 | eee@email.com | | 3 | 9999, 0000 |

TABLE 2

| ID | Priority | Task name | Working location |
|---|---|---|---|
| 1 | 5 | Ship completed product | 2nd floor, Building B |
| 2 | 3 | Transport parts | 2nd floor, Building A |
| 3 | 8 | Clean line A | 2nd floor, Building A |
| 4 | 1 | Clean line B | 1st floor, Building B |

An example of a method for acquiring personal information will be described below focusing on a case of using information managed as the above-described person list and task list. In this case, for example, the personal information acquisition unit 303 acquires information about one row (information about one person) from the person list illustrated in Table 1, acquires task information from the task list illustrated in Table 2 by using information about the task identifier (ID) of the active task as a key, and integrates these pieces of information.

The ID column of the person list illustrated in Table 1 indicates the personal information described in each row, i.e., the ID for identifying a person corresponding to the personal information. The “Contact address” column denotes the contact address of the person corresponding to the personal information described in each row. The “Personal skill” column denotes the personal skill of the person corresponding to the personal information (in other words, the problem-solving capability of the target person) described in each row. The skill described in the “Personal skill” column may be suitably limited in consideration of the use case of the system. As a specific example, each person generally has general skills such as the skill to open a door and the skill to move to the destination, and therefore general skills may be excluded from explicit descriptions of the “Personal skill” column. The “Active task ID” column denotes the ID of the task being executed by the person corresponding to the personal information described in each row. The tasks corresponding to the task ID are managed in the task list illustrated in Table 2. The “Current location” column denotes the coordinates of the current position of the person corresponding to the personal information described in each row.

The ID column of the task list illustrated in Table 2 indicates the ID of the task corresponding to the task information described in each row. The Priority column denotes the priority of the task corresponding to the task information described in each row. According to the present exemplary embodiment, a task having a larger value of the Priority column is defined as a task having a higher priority. The “Task name” column denotes the name of the task corresponding to the task information described in each row. The “Working location” column denotes the location where the task is executed.

Although the person list illustrated in Table 1 manages personal information about five different persons as examples, the number of persons under management is not limited thereto. More specifically, the larger number of persons or the smaller number of persons may be under management. Although the task list in Table 2 manages task information about four different tasks as examples, the number of tasks under management is not limited thereto. More specifically, the larger number of tasks or the smaller number of tasks may be under management.

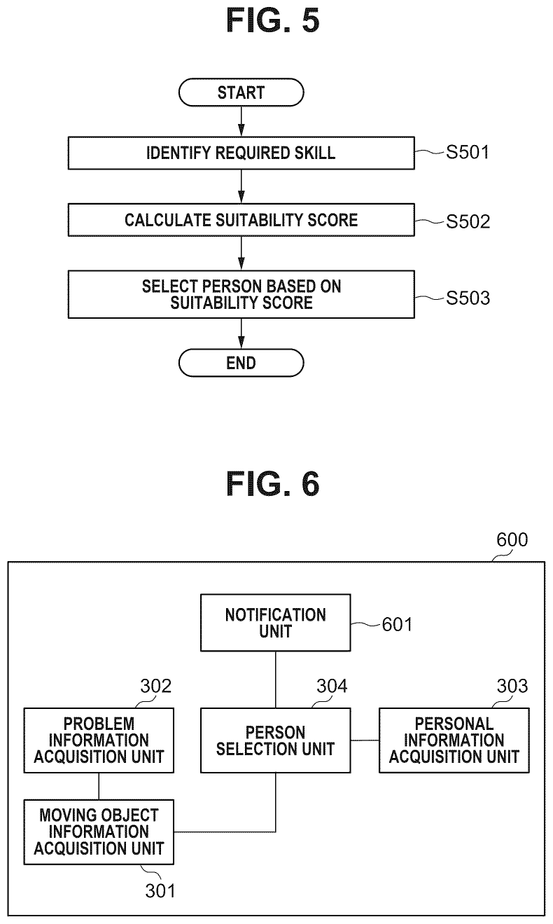

In step S404, the person selection unit 304 selects a person who solves the problem identified in step S402. The processing in step S404 will be separately described in detail below with reference to FIG. 5.

The personal information acquisition unit 303 determines whether the series of processes indicated by the loop symbols in steps S403 and S405 is completed for all persons under management. If the personal information acquisition unit 303 determines that the processes are completed for all persons, the processing exits this flowchart.

An example of processing for selecting a problem-solving person as the processing in step S404 in FIG. 4 will be described below with reference to FIG. 5.

In step S501, the person selection unit 304 identifies the skill required to solve the problem according to the type of the problem identified in step S402 in FIG. 4. To identify the skill required to solve each problem, the person selection unit 304 uses information managed, for example, based on a database as a problem list illustrated in table 3.

TABLE 3

| ID | Problem name | Required skill |
|---|---|---|
| 1 | Closed door on path | |
| 2 | Path blocked by cargo | Lift heavy load |
| 3 | Collapsed cargo | Lift heavy load |
| 4 | Run-off | Lift heavy load |
| 5 | Others | |

The ID column illustrated in Table 3 indicates the ID for identifying each of the plurality of problems under management. The “Required skill” column denotes the skill required to solve the problem corresponding to the information described in each row.

The example of a problem list illustrated in Table 3 manages information about five different problems. However, the problem list is to be considered as illustrative, and the number of problems under management is not limited thereto. More specifically, the larger number of problems or the smaller number of problems may be under management.

In step S502, the person selection unit 304 calculates the suitability score representing the suitability of the person indicated by the personal information in solving the target problem, based on the personal information acquired in step S403 in FIG. 4 and the required skill information acquired in step S501. This suitability score may be calculated, for example, by weighting each of a series of parameters included in the personal information and then adding the series of weighted parameters. According to the present exemplary embodiment, the suitability score is calculated based on calculation equation 1.

$$Score = {d}_{t} {T}_{X} + {d}_{S} {S}_{x} + {d}_{p} {P}_{x} \qquad ( Equation 1 )$$

dₜ: Weighting factor for task priority
Tₓ: Priority of task being executed by person x
dₛ: Weighting factor for presence or absence of personal skill
Sₓ: Whether person x has required skill
dₚ: Weighting factor for distance
Pₓ: Distance between occurrence position of problem and person x

In the above-described equation 1, de denotes a positive weighting factor for the task priority set in advance. Tₓ denotes the priority of the task being executed by the target person (the person indicated by the personal information). As the task priority described in the Priority column of the task list illustrated in Table 2, the information acquired in step S403 in FIG. 4 is applied. dₛ denotes a positive weighting factor for the presence or absence of the skill set in advance. Sₓ having a value of 0 or 1 denotes whether the target person has the skill required to solve the target problem. More specifically, if the skill required to solve the problem acquired in step S501 is included in the personal skill of the personal information acquired in step S403 in FIG. 4, the value of Sₓ is set to 1. If the skill is not included in the personal skill, the value of Sₓ is set to 0. dₚ denotes a negative weighting factor for the distance between the occurrence position of the problem and the target person set in advance. According to the present exemplary embodiment, dₚ is set to a negative value so that the score increases with decreasing distance between the occurrence position of the problem and the target person. Pₓ denotes the distance between the above-descried occurrence position of the problem and the above-described person. As the distance between the occurrence position of the problem and the person, for example, the direct distance between the occurrence position of the problem identified in step S402 in FIG. 4 and the current position of the person indicated by the personal information acquired in step S403 is applied.

As Pₓ, the distance between the moving path where the target person moves to execute the task and the occurrence position of the problem is also applicable. Applying such control also enables calculating the as high suitability score as possible of the person passing near the occurrence position of the problem while moving to execute the task. Therefore, for example, if the person passing near the occurrence position of the problem while moving to execute the task takes a detour, the problem can also be solved by the person.

In step S503, the person selection unit 304 determines the problem-solving person from among the plurality of persons under management based on the suitability score calculated in step S502. More specifically, the person selection unit 304 stores the suitability score calculated in step S502 and the processing target personal information in an associated way, in the loop of the series of processes indicated by the loop symbols in steps S403 and S405 in FIG. 4. Then, upon execution of the processing in step S503, the person selection unit 304 only needs to determine the person indicated by the personal information stored in association with the highest suitability score, as a problem-solving person.

Although the present exemplary embodiment has been described above centering on an example case where the moving object information acquisition unit 301 acquires the self-position of the target moving object, the currently active task, and the task importance in step S401 in FIG. 4. However, the information to be acquired is not limited thereto. More specifically, at least the self-position of the target moving object only needs to be acquired. Information other than the above-described information may be acquired, or only the self-position of the moving object may be acquired.

According to the present exemplary embodiment, the problem information acquisition unit 302 detects a problem of a closed door on the path, a problem of the path blocked by the cargo, a problem of the collapsed cargo on the moving object, and a problem of run-off of the moving object in step S402 in FIG. 4. However, detection target problems are not limited thereto. As specific examples, problems other than the above-described examples may be set as detection targets, or some of the above-described examples may be set as detection targets.

The present exemplary embodiment has been described above centering on an example case where the problem information acquisition unit 302 detects an obstacle by using laser sensors installed on the moving object in step S402 in FIG. 4. However, the detection method is not limited thereto as long as the method can detect an obstacle blocking the path of the moving object. As a specific example, the problem information acquisition unit 302 may acquire information from a monitoring camera installed on the environment where the moving object is operating, and compare the acquired information with map information about the environment to detect an obstacle on the path of the target moving object. As another example, if the moving object is provided with an imaging apparatus, the problem information acquisition unit 302 may use images corresponding to the result of capturing the periphery of the moving object to identify the type of the problem that has occurred on the moving object. In this case, a model that has completed learning based on a machine learning technique may be applied. The model has learned to identify a problem occurring on a target moving object based on input images.

The present exemplary embodiment has been described above centering on an example case where the personal information acquisition unit 303 acquires the contact address, the personal skill, the currently active task, the priority of the active task, and the current position as the personal information in step S403 in FIG. 4. However, the information to be acquired is not limited thereto. More specifically, at least the contact address and the personal skill only needs to be acquired. Information other than the above-described information may be acquired, or part of the above-described information may be acquired.

The present exemplary embodiment has been described above centering on an example case where the problem information acquisition unit 302 identifies a problem of a closed door on the path, a problem of the path blocked by the cargo, a problem of the collapsed cargo on the moving object, and a problem of run-off of the moving object in step S402 in FIG. 4. However, problems to be identified are not limited thereto.

More specifically, problems other than the above-described problem may be identified, or some of the above-described problems may be identified.

The present exemplary embodiment has also been described above centering on an example case where the personal information acquisition unit 303 acquires personal information from a pre-generated database. Meanwhile, the personal information may be acquired in real time by providing on each moving object a sensor for measuring the current position and an interface for receiving a task information input. Information collection may be performed in real time by using collected information about persons in the environment and devices held by each person. Applying these components enables, for example, providing an expectation for improving the efficiency of the database management cost.

The present exemplary embodiment has been described above centering on an example case where the person selection unit 304 selects the person who solves a problem based on the suitability score in step S503 in FIG. 5. As another example of applicable control, the person selection unit 304 determines, before selecting a problem-solving person, whether the target problem is such a problem that will be solved after waiting. If the problem is such a problem, the person selection unit 304 makes the moving object wait until the problem is solved, without selecting a problem-solving person. In this case, for example, the person selection unit 304 may determine whether a person passes the occurrence position of the problem identified by the problem information acquisition unit 302, and, based on the result of the determination, determine whether the problem is such a problem that will be solved after waiting. For example, the person selection unit 304 can determine whether a person passes the occurrence position of the problem, based on the occurrence position of the problem, the current position of the target person included in the personal information acquired by the personal information acquisition unit 303, and the currently active task. In this case, if the occurrence position of the problem exists on the path between the current position of the target person and the working location of the currently active task (in other words, the moving path of the person), the person selection unit 304 can determine that the problem will be solved by the person when the person passes the occurrence position of the problem. In other words, in such a case, the person selection unit 304 can determine that the problem will be solved after waiting.

If the person selection unit 304 determines whether the moving object itself can solve the problem that has occurred, and determines that the moving object itself can solve the problem, the moving object itself may solve the problem without selecting a problem-solving person in the processing in step S503 in FIG. 5. An example of a method for determining whether the moving object itself can solve a problem will be described below.

Firstly, the information processing apparatus determines the type of the identified problem is a problem of the path (the path blocked by the cargo or a closed door on the path) or a problem of the moving object itself (the collapsed cargo or run-off).

If the type of the identified problem is a problem of the path, the information processing apparatus may search for another path with which the moving object reaches the destination, and, if another path exists, may determine that the problem can be solved by the moving object itself. If no other paths exist, the information processing apparatus may determine that the problem can hardly be solved by the moving object itself.

If the identified problem is a problem that has occurred on the moving object itself, the information processing apparatus additionally acquires the specifications of the moving object and determines whether the moving object itself can solve the target problem (the collapsed cargo or run-off) by using functions specified by the specifications. If a series of functions in the specifications includes no function of enabling the moving object itself to solve the problem, the information processing apparatus may determine that the problem can hardly be solved by the moving object itself. If a series of functions in the specifications includes a function of enabling the moving object itself to solve the problem, the information processing apparatus allows the moving object to solve the problem by using the function. On that basis, if the moving object itself fails to solve the problem, the information processing apparatus may determine that the problem can hardly be solved by the moving object itself.

Applying the above-described control enables reducing the identification of a person who solves the problem having occurred and the frequency of a notification to the person, providing an expectation for improving the working efficiency.

The present exemplary embodiment has been described above centering on an example case where the selection of a problem-solving person is made once in solving a problem of the moving object. However, the selection of a problem-solving person may be made a plurality of times. For example, if the problem is not solved within a predetermined time period after selecting a problem-solving person, the selection of a problem-solving person may be made again. This enables preventing a situation where the moving object keeps waiting until the problem having occurred is solved by the selected problem-solving person, providing an expectation for solving the problem as soon as possible.

The present exemplary embodiment has been described above centering on an example case where the suitability score is calculated by using the priority of the task being executed by a person, the presence or absence of the personal skill, and the distance between the occurrence position of the problem and the person. However, the method for calculating the suitability score is not limited thereto. As a specific example, the suitability score may be calculated in consideration of the number of times each of the persons under management solved problems in the past. In this case, the personal information acquisition unit 303 may acquire information about the number of times the target person solved problems in the past, as personal information. As another example, the suitability score may be calculated in consideration of the correlation between the task being executed by the moving object and the task being executed by a person. In this case, the personal information acquisition unit 303 may acquire information about the task being executed by the target person, as personal information. On that basis, the person selection unit 304 may calculate the correlation between the task being executed by the target moving object and the task being executed by the target person. Applying such control enables selecting a more suitable person as a problem-solving person in solving the target problem.

The present exemplary embodiment has been described above centering on a method for adding the result of weighting each parameter as the method for calculating the suitability score. However, the method for calculating the score to be applied as the above-described suitability score is not limited thereto. As a specific example, any one of the parameters is selected, and the value of the parameter may be applied as the suitability score. As another example, a plurality of parameters may be compared, and the number of relative merits may be applied as the suitability score. As still another example, the simple sum total of the parameters may be applied as the suitability score. This enables improving the efficiency of the calculation of the suitability score.

The present exemplary embodiment has been described above centering on an example case where one problem-solving person is selected in step S503 in FIG. 5. However, a plurality of problem-solving persons may be selected. In this case, for example, upon execution of the processing in step S503, the person selection unit 304 may sort target persons in descending order of the suitability score, and then select the predetermined number of persons having higher scores as problem-solving persons. The number of problem-solving persons to be selected may be changed according to the priority of the task being executed by the moving object. As a specific example of applicable control, the number of problem-solving persons to be selected is decreased with decreasing task priority and increased with increasing task priority. In this case, the moving object information acquisition unit 301 only needs to acquire information about the priority of the task being executed by the target moving object as information about the moving object. Applying such control provides an expectation for the increased possibility that a problem is solved, in comparison with a case where only one problem-solving person is selected.

A second exemplary embodiment of the present disclosure will be described below. The first exemplary embodiment has been described above centering on an example case where a problem-solving person is selected based on the suitability score. The second exemplary embodiment is different from the first exemplary embodiment in that the information processing apparatus includes a notification unit 601 in addition to the components of the first exemplary embodiment described above with reference to FIG. 3. With this configuration, the information processing apparatus according to the present exemplary embodiment attempts to solve a problem by transmitting a notification of requesting to solve the problem that has occurred on a moving object, to the person selected by the person selection unit 304. The present exemplary embodiment will be described below focusing on differences from the first exemplary embodiment, and descriptions of elements substantially the same as those according to the first exemplary embodiment will be omitted.

An example of a functional configuration of the information processing apparatus according to the present exemplary embodiment will be described below with reference to FIG. 6.

As described above, the information processing apparatus according to the present exemplary embodiment includes the notification unit 601 in addition to the components of the information processing apparatus 300 according to the first exemplary embodiment described above with reference to FIG. 3.

The notification unit 601 transmits a notification to the person selected by the person selection unit 304, based on the personal information (e.g., information about the contact address) acquired by the personal information acquisition unit 303.

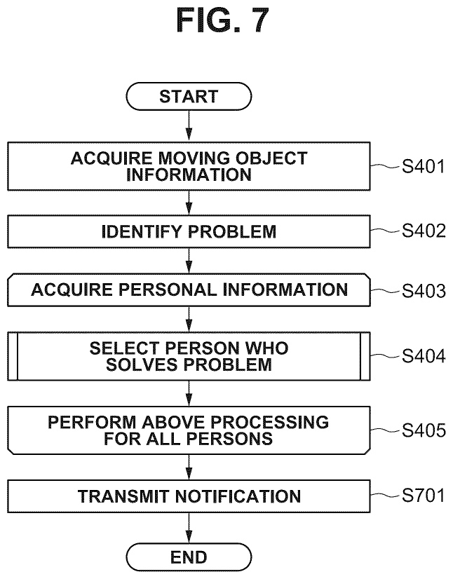

An example of processing of the information processing apparatus according to the present exemplary embodiment will be described below with reference to FIG. 7. A series of processes illustrated in FIG. 7 is different from the series of processes of the information processing apparatus according to the first exemplary embodiment described above with reference to FIG. 4 in that the processing in step S701 is added.

In step S701, the notification unit 601 transmits a notification of requesting to solve the problem that has occurred on the moving object, to the problem-solving person selected in step S404. Examples of contents of the notification to be transmitted include information about identifying the moving object having the problem, information about the type and occurrence position of the problem acquired by the problem information acquisition unit 302, the importance of the task acquired in step S401, and a message for requesting to solve the problem. The notification is transmitted, for example, by E-mail. In this case, the notification unit 601 will transmit the above-described E-mail to the contact address included in the personal information acquired by the personal information acquisition unit 303.

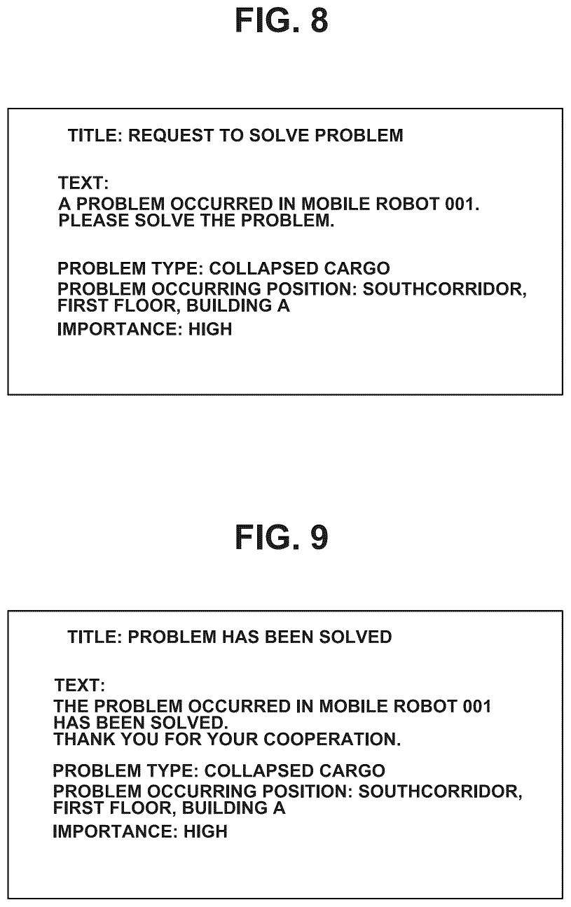

An example of contents of the notification to be transmitted to the problem-solving person by the notification unit 601 will be described below with reference to FIG. 8.

Referring to FIG. 8, the title field on the e-mail screen is supplied with the title of the e-mail to be transmitted. The title indicates that this mail is a request to solve the problem. The text field on the e-mail screen is supplied with the text of the e-mail to be transmitted. More specifically, the text includes the name of a moving object 001 as information about identifying the moving object causing a problem.

The text includes the problem type, the occurrence position of the problem, and the importance.

If the above-described notification of requesting to solve the problem is transmitted to the person selected by the person selection unit 304, it becomes possible to prompt the person to solve the problem that has occurred on the moving object.

The present exemplary embodiment has been described above centering on an example case where a notification is transmitted by E-mail. However, the method for transmitting a notification is not limited to E-mail but various methods for transmitting a notification are also applicable. As a specific example, in the personal information acquired by the personal information acquisition unit 303, the telephone number may be managed as contact information, and a notification may be transmitted to the problem-solving person by telephone. In this case, for example, a notification of information about identifying the moving object having a problem, information about a problem that has occurred on the moving object, or the like may be transmitted to the problem-solving person, for example, by using mechanically synthesized voice. A notification (such as a push type pop-up) may be transmitted in collaboration with an application installed on a communication terminal such as a smart phone of the person under management. Applying diverse types of notification methods enables providing an expectation for improving the convenience of the system.

The present exemplary embodiment has been described above centering on an example case where a notification is transmitted once. However, a notification may be transmitted a plurality of times. As a specific example, if the problem is not solved even in a case where a predetermined period of time has elapsed since a notification transmission, the notification may be retransmitted to the target problem-solving person. Applying such control enables newly prompting the problem-solving person to solve the problem, thus attempting to solve the problem as soon as possible.

If the problem is solved after the notification transmission, the target problem-solving person may be notified of the solution of the problem. FIG. 9 illustrates an example of contents of a notification of the solution of a problem, transmitted by E-mail.

Referring to FIG. 9, the title field on the e-mail screen is supplied with the title of the e-mail to be transmitted. The title indicates that the problem has been solved. The text field on the e-mail screen is supplied with the text of the e-mail to be transmitted. More specifically, the text includes the name of a moving object 001 as information about identifying the moving object causing a problem. The text describes the problem type, the occurrence position of the problem, and the importance.

An example case where a notification is transmitted by E-mail has been described above. However, like in the case of requesting to solve a problem, not only E-mail but also various methods are also applicable to transmit a notification. As a specific example, notifying the problem-solving person that the problem has been solved can be implemented by a voice notification by telephone or a push type pop-up notification by an application installed on a terminal such as a smart phone.

Applying the above-described control enables preventing the occurrence of a situation where, even after the problem has been solved, another problem-solving person not involved in solving the problem takes an action to solve the problem. This provides an expectation for improving the working efficiency.

A third exemplary embodiment of the present disclosure will be described below. The first exemplary embodiment has been described above centering on an example case where a problem-solving person is selected based on the suitability score. The third exemplary embodiment is different from the first exemplary embodiment in that the information processing apparatus includes a task information correction unit 1001 in addition to the components of the first exemplary embodiment described above with reference to FIG. 3. With this configuration, the information processing apparatus according to the present exemplary embodiment corrects the task information about the problem-solving person selected by the person selection unit 304, thus prompting the problem-solving person to solve a problem that has occurred on a target moving object. The present exemplary embodiment will be described below focusing on differences from the first exemplary embodiment, and descriptions of elements substantially the same as those according to the first exemplary embodiment will be omitted.

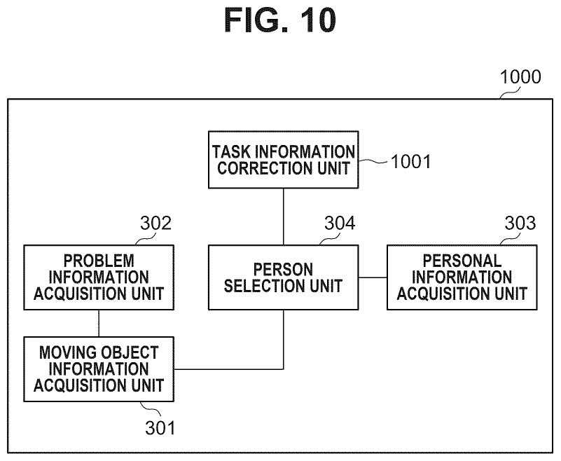

An example of a functional configuration of the information processing apparatus according to the present exemplary embodiment will be described below with reference to FIG. 10. As described above, the information processing apparatus according to the present exemplary embodiment includes a task information correction unit 1001 in addition to the components of the information processing apparatus 300 according to the first exemplary embodiment described above with reference to FIG. 3.

The task information correction unit 1001 corrects the task information targeting the problem-solving person selected by the person selection unit 304.

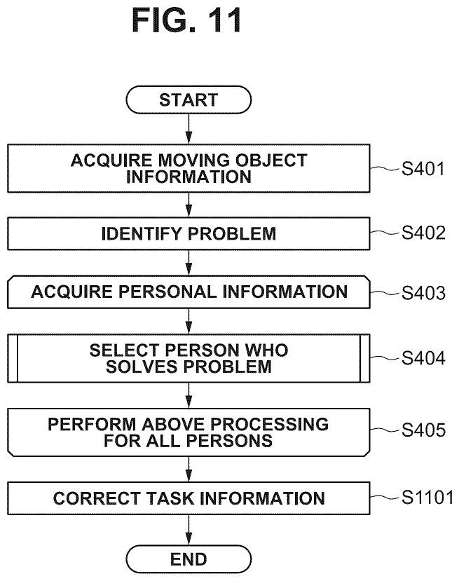

Then, an example of processing of the information processing apparatus according to the present exemplary embodiment will be described below with reference to FIG. 11. A series of the processes illustrated in FIG. 11 is different from the series of processes of the information processing apparatus according to the first exemplary embodiment described above with reference to FIG. 4 in that the processing in step S1101 is added.

In step S1101, the task information correction unit 1001 identifies a task that collaterally solves the problem identified in step S402, based on the task information about the problem-solving person identified in step S404, and then corrects the task information based on the result of the identification.

An example of a method for identifying a task that collaterally solves a problem will be described below. The person selection unit 304 acquires a list of tasks to be executed by the selected person, and identifies from the list a task that necessitates the passage through the occurrence position of the problem for which information has been acquired in step S401, as a task that collaterally solves the problem. For example, the person selection unit 304 determines whether a task necessitates the passage through the occurrence position of the problem in the following way.

More specifically, the task information correction unit 1001 extracts the current position of the person selected in step S404 from the personal information acquired in step S403. If the occurrence position of the problem identified in step S402 exists on the moving path from the extracted current position of the person to the working location indicated by the task information acquired in step S403, the task information correction unit 1001 determines that the task necessitates the passage through the occurrence position of the problem.

Then, the task information correction unit 1001 corrects information described in the Priority column of the target task in the database of the task list illustrated in Table 2.

Since the task information about the problem-solving person selected by the person selection unit 304 is modified, the task having the increased priority is preferentially executed. This enables prompting the problem-solving person to quickly solve the problem having occurred on a moving object.

The present exemplary embodiment has been described above centering on an example case where the priority of the task that collaterally solves the problem is increased. However, a task that collaterally solves the problem may be generated by changing the path used by a specific task to include the occurrence position of a problem having occurred on the moving object. In this case, information about the path to be used by the target task needs to be added to the database of the task list illustrated in Table 2. This enables using the technique according to the present exemplary embodiment even in a case where there is no task that collaterally solves a problem.

As another example, the task information correction unit 1001 may prompt the problem-solving person to quickly execute the task for solving the problem by adding information about the task for solving the problem identified in step S402 to the database of the task list illustrated in Table 2, and setting a high priority. This enables using the technique according to the present exemplary embodiment even in a case where there is no task that collaterally solves the problem.

A fourth exemplary embodiment of the present disclosure will be described below. The first exemplary embodiment has been described above centering on an example case where a problem-solving person is selected based on the suitability score. The fourth exemplary embodiment is different from the first exemplary embodiment in that the information processing apparatus includes a reward determination unit 1201 in addition to the components of the first exemplary embodiment described above with reference to FIG. 3. With this configuration, the information processing apparatus according to the present exemplary embodiment determines the reward to be given to the problem-solving person selected by the person selection unit 304, when the person solves the problem. This improves the motivation for the problem-solving person to solve the problem. The present exemplary embodiment will be described below focusing on differences from the first exemplary embodiment, and descriptions of elements substantially the same as those according to the first exemplary embodiment will be omitted.

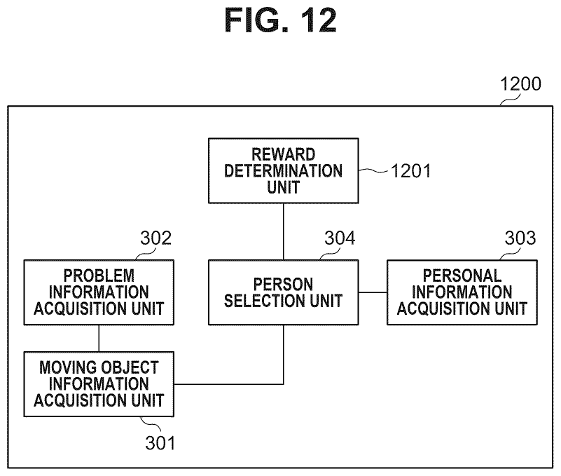

An example of a functional configuration of the information processing apparatus according to the present exemplary embodiment will be described below with reference to FIG. 12. As described above, the information processing apparatus according to the present exemplary embodiment includes the reward determination unit 1201 in addition to the components of the information processing apparatus 300 according to the first exemplary embodiment described above with reference to FIG. 3.

The reward determination unit 1201 determines the reward to be given to the problem-solving person selected by the person selection unit 304. The reward to be given to the problem-solving person is determined, for example, based on the suitability score calculated by the person selection unit 304.

The reward to be given to the problem-solving person when the problem is solved by the problem-solving person selected by the person selection unit 304 is determined in this way. This provides an expectation for improving the motivation for the problem-solving person to solve the problem.

The present exemplary embodiment has been described above centering on an example case where the reward is determined based on the suitability score calculated by the person selection unit 304. However, the reward may be determined based on the importance of the task being executed by the moving object when a problem occurs on the moving object. Applying such control improves the value of the reward to be given when a problem that has occurred on the moving object currently executing a more important task is solved. In particular, this provides an expectation for improving the motivation to solve the problem that has occurred on the moving object currently executing a highly important task.

As another example of applicable control, a preset fixed reward is given. As another example of an applicable configuration, the result of determining the reward is transmitted to a central management apparatus for managing the reward for each person, and the problem-solving person receives the reward via the central management apparatus.

### Other Exemplary Embodiments

The present disclosure has been described in detail above based on a plurality of exemplary embodiments. The present disclosure can be embodied, for example, in a form of a system, an apparatus, a method, a program, or a recording medium (storage medium). More specifically, the present disclosure is applicable to a system composed of a plurality of devices (including a host computer, an interface device, an imaging apparatus, and a web application) and to an apparatus composed of one device.

A recording medium (or a storage medium) recording a software program code (computer program) for implementing the functions of the above-described exemplary embodiments is supplied to a system or an apparatus. The storage medium is a computer-readable storage medium. A computer (or CPU or micro processing unit (MPU)) of the system or apparatus reads and executes the program code stored in the recording medium. In this case, the program code itself read from the recording medium implements the functions of the above-described exemplary embodiments, and the recording medium recording the program code is included in the present disclosure.

If a problem occurs to disturb the task execution by a moving object, the present disclosure solves the problem in a more suitable form.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-065450, filed Apr. 15, 2024, which is hereby incorporated by reference herein in its entirety.

What is claimed is:

1. An information processing apparatus comprising:
a moving object information acquisition unit configured to acquire information about a moving object under management;
a problem information acquisition unit configured to, if a problem occurs to disturb a task execution by the moving object, acquire information about details of the problem;
a personal information acquisition unit configured to acquire attribute information about at least one candidate of a problem-solving person; and
a person selection unit configured to select a problem-solving person from the at least one candidate based on the information about the moving object acquired by the moving object information acquisition unit, the information about details of the problem acquired by the problem information acquisition unit, and the attribute information about the at least one person acquired by the personal information acquisition unit.

2. The information processing apparatus according to claim 1, wherein the person selection unit selects the problem-solving person based on a problem-solving capability of a selection target person.

3. The information processing apparatus according to claim 1, wherein the person selection unit selects the problem-solving person based on at least a distance between a current position of a selection target person and an occurrence position of the problem or a distance between a moving path of the selection target person and the occurrence position of the problem.

4. The information processing apparatus according to claim 1, wherein the person selection unit selects the problem-solving person based on an importance of a task being executed by a selection target person.

5. The information processing apparatus according to claim 1, wherein the person selection unit selects the problem-solving person based on at least two of a problem-solving capability of a selection target person, a distance between a current position of the selection target person and an occurrence position of the problem, or a distance between a moving path of the selection target person and the occurrence position of the problem.

6. The information processing apparatus according to claim 1, further comprising a notification unit configured to transmit a notification corresponding to the information about details of the problem acquired by problem information acquisition unit to the person selected by the person selection unit.

7. The information processing apparatus according to claim 1, further comprising a correction unit configured to correct information about a task to be executed by the person selected by the person selection unit.

8. The information processing apparatus according to claim 1, further comprising a reward determination unit configured to determine, in case where the person selected by the person selection unit solves the problem, a reward to be given to the person.

9. A method for controlling an information processing apparatus, the method comprising:
acquiring information about a moving object under management;
acquiring information about details of the problem if a problem occurs to disturb a task execution by the moving object;
acquiring attribute information about at least one candidate of a problem-solving person; and
selecting a problem-solving person from the at least one candidate based on the acquired information about the moving object, the acquired information about details of the problem, and the acquired attribute information about the at least one person.

10. The method according to claim 9, wherein the person selecting selects the problem-solving person based on a problem-solving capability of a selection target person.

11. The method according to claim 9, wherein the person selecting selects the problem-solving person based on at least a distance between a current position of a selection target person and an occurrence position of the problem or a distance between a moving path of the selection target person and the occurrence position of the problem.

12. The method according to claim 9, wherein the person selecting selects the problem-solving person based on an importance of a task being executed by a selection target person.

13. The method according to claim 9, wherein the person selecting selects the problem-solving person based on at least two of a problem-solving capability of a selection target person, a distance between a current position of the selection target person and an occurrence position of the problem, or a distance between a moving path of the selection target person and the occurrence position of the problem.

14. The method according to claim 9, further comprising transmitting a notification corresponding to the acquired information about details of the problem to the selected person.

15. The method according to claim 9, further comprising correcting information about a task to be executed by the selected person.

16. The method according to claim 9, further comprising determining, in case where the selected person solves the problem, a reward to be given to the person.

17. A non-transitory computer-readable storage medium storing a computer-executable program for causing a computer to perform a method, the method comprising:
acquiring information about a moving object under management;
acquiring information about details of the problem if a problem occurs to disturb a task execution by the moving object;
acquiring attribute information about at least one candidate of a problem-solving person; and
selecting a problem-solving person from the at least one candidate based on the acquired information about the moving object, the acquired information about details of the problem, and the acquired attribute information about the at least one person.
